(19) United States
(12) Patent Application Publication
(10) Pub. No.: US 2022/0021887 A1
(43) Pub. Date: Jan. 20, 2022

(54) Apparatus for Bandwidth Efficient Video Communication Using Machine Learning Identified Objects Of Interest

(71) Applicant: Wisconsin Alumni Research Foundation, Madison, WI (US)

(72) Inventors: Suman Banerjee, Madison, WI (US); Peng Liu, Cupertino, CA (US); Varun Chandrasekaran, Madison, WI (US)

(21) Appl. No.: 16/928,690

(22) Filed: Jul. 14, 2020

(51) Int. Cl. H04N 19/167; H04N 19/146; H04N 19/176; G06N 20/00

(52) U.S. Cl. CPC H04N 19/167; G06N 20/00; H04N 19/176; H04N 19/146

(57) ABSTRACT

A video compression/decompression system employs a machine learning model to extract regions of interest from the input video to define relatively higher bit rate portions of the video frames that are transmitted. The resulting compressed data may be transmitted using standard protocols without specialized decoders but may optionally include a second machine learning model trained at the transmitter to boost the resolution of the reconstructed compressed data emphasizing the region of interest.

### STATEMENT REGARDING FEDERALLY SPONSORED RESEARCH OR DEVELOPMENT

This invention was made with government support under 1719336 awarded by the National Science Foundation. The government has certain rights in the invention.

### CROSS REFERENCE TO RELATED APPLICATION

--

### BACKGROUND OF THE INVENTION

The present invention relates to region of interest (ROI) encoding for communicating and compressing video transmissions, and in particular to a system employing machine learning to identify the regions of interest and/or to boost receiver resolution.

The communication of video information requires substantial network bandwidth and accordingly there is great interest in reducing the amount of data that needs to be transmitted while preserving perceptual quality. Particularly with portable devices such as cell phones, compression can be critical to working within the bandwidth restraints of the cellular network system and reducing transmitter power in a battery-powered device.

Video transmissions, either in real time or in a streamed form, consist of a sequence of video frames. Each frame describes an array of pixels capturing a snapshot of a moving image in time. Commonly, this video information is compressed without loss of information, for example, by identifying spatial redundancy of pixels within a video frame or temporal redundancy of pixels between video frames and reducing or eliminating these redundant transmissions.

The video information may also be compressed by discarding information, for example, by reducing the bit depth of the pixels (the number of bits used to represent a pixel) or reducing the bit rate of the pixels (how frequently the pixel values are updated).

All of these compression systems will generally be termed “bit rate” corrections because they affect the number of bits per second that are transmitted.

Current bit rate compression systems can break a video frame into macro-blocks which can each be associated with different levels of quantization (e.g., how many discrete values are used to represent the macro-block). The ability to use macro-blocks to apply different amounts of compression to different portions of the video frame has led to systems that identify particular regions of interest (ROIs) in a video stream, for example, the human face. These compression systems selectively encode the macro-blocks associated with the face at a higher bit rate, based on the assumption that the face will be of primary interest to the viewer.

### SUMMARY OF THE INVENTION

The present invention provides a significant improvement to region of interest encoding by enlisting machine learning techniques, often used to categorize objects within an image, to identify one or more regions of interest for the purpose of compression. The inventors have recognized that the computational intensity of this process may be accommodated with standard portable devices such as cell phones through the use of edge computing. Machine learning can also be used to develop a compact model based of the video stream that can be transmitted to the receiver. This is used to enable super resolution at the receiver, further emphasizing the region of interest identified in the video stream.

More specifically, in one embodiment, the invention provides a video compression system comprising of a region of interest extractor receiving an input stream of video frames. This extractor identifies a region of interest by applying the input stream of video frames to a machine learning model trained to identify a predetermined region of interest. The system also comprises of a bit rate compressor receiving an input stream of video frames and the region of interest and outputting an output stream of video frames based on both the input stream and a region of interest (defining a first portion of the video frames) of the input stream. The bit rate compressor encodes the first portion of the video frames at a relatively higher bit rate than second portion of the video frames outside of the first portion.

It is thus a feature of at least one embodiment of the invention to leverage the robust ability of machine learning to identify and isolate (segment) objects in an image, for the purpose of region of interest-based video compression.

The machine learning model may identify regions of interest selected from the group consisting of at least one of a person, a person's face, or a black/whiteboard in the video frames.

It is thus a feature of at least one embodiment of the invention to permit practical pre-training of the machine learning models by abstracting categories that are broadly useful in many streaming and real time video conferencing applications.

The higher bit rate may be realized by at least one of a greater bit depth in pixels of the output stream of video frames and a greater bit transmission rate of pixels in the output stream of the video frame.

It is thus a feature of at least one embodiment of the invention to provide a region of interest identification system that can work flexibly with a wide variety of different compression systems to manage bit rate.

In one embodiment, the region of interest extractor may include multiple machine learning models each trained to identify a different region of interest in the input stream of video frames and the video compression system may include an input for receiving a region of interest selector signal to select among the different machine learning models.

It is thus a feature of at least one embodiment of the invention to permit flexible, dynamic selection of the region of interest, for example, depending on video content or viewer preference.

The bit rate compressor may divide each video frame of the input stream into macro-blocks and provides a different amount of compression to corresponding macro-blocks of each video frame of the output stream according to whether the region of interest overlaps the macro-block. Likewise, the invention contemplates a bit rate decompressor communicating with the bit rate compressor to receive the output stream to provide different amounts of decompression to each macro-block of the output stream according to information transmitted with the macro-blocks of the output stream.

It is thus a feature of at least one embodiment of the invention to provide an output stream of video frames that can be easily handled by standard decompressors without global changes to existing network infrastructure or hardware.

The video compression system may further include a super resolution preprocessor receiving the input stream of video frames and the output stream of video frames as a training set to develop a machine learning super resolution model relating the input video stream to the output video stream. The video compression system may transmit weights associated with the machine learning super resolution model with the output stream of video frames for use in reconstructing a viewable video stream. The invention further contemplates, and in some cases includes a super resolution post processor receiving the transmitted weights from the super resolution preprocessor. The super resolution post processor then communicates with a bit rate decompressor receiving the output stream of video frames from the bit rate compressor to to enhance perceptual quality through the process of super resolution In this case, the super resolution post processor applies the decompressed video stream to the machine learning super resolution model using the transmitted weights to enhance the viewable video stream.

It is thus a feature of at least one embodiment of the invention to leverage machine learning to boost the apparent information content of the received video signal. By training the transmitter-side machine learning models using output data processed according to a region of interest, the region of interest is preferentially improved in the ultimate video output (for example, boosting apparent resolution or eliminating region of interest compression artifacts). The weights associated with the machine learning super resolution model maybe updated on a periodic basis during the video transmission.

It is thus a feature of at least one embodiment of the invention to make use of the fact that the training sets for the machine learning super resolution models are automatically generated eliminating much of the problem of data cleaning and formatting required in machine learning models.

The video compression system may further provide for multiple network connections and routing data among those connections.

It is thus a feature of at least one embodiment of the invention to make use of edge computing capabilities rendering the present invention practical for lower powered mobile devices.

These particular objects and advantages may apply to only some embodiments falling within the claims and thus do not define the scope of the invention.

### BRIEF DESCRIPTION OF THE DRAWINGS

FIG. 1 is a diagram of a communication path between a video transmitter through a network including edge routers to a video receiver, for example, and portable devices communicating wirelessly with the Internet, suitable for use with the present invention.

FIG. 2 is a block diagram of an encoder and a decoder, for example, implemented by the edge routers of FIG. 1, for sending compressed data between the video transmitter and video receiver of FIG. 1 providing adaptive bit rate communication providing multiple macro-blocks;

FIG. 3 is a detailed block diagram of one compression block of FIG. 2 for a particular bit rate showing a region of interest extractor and a super resolution module;

FIG. 4 is an alternative embodiment of FIG. 3 providing for user selectable regions of interest encoding; and

FIG. 5 is a diagrammatic representation of a training set used for training the region of interest extractor.

### DETAILED DESCRIPTION OF THE PREFERRED EMBODIMENT

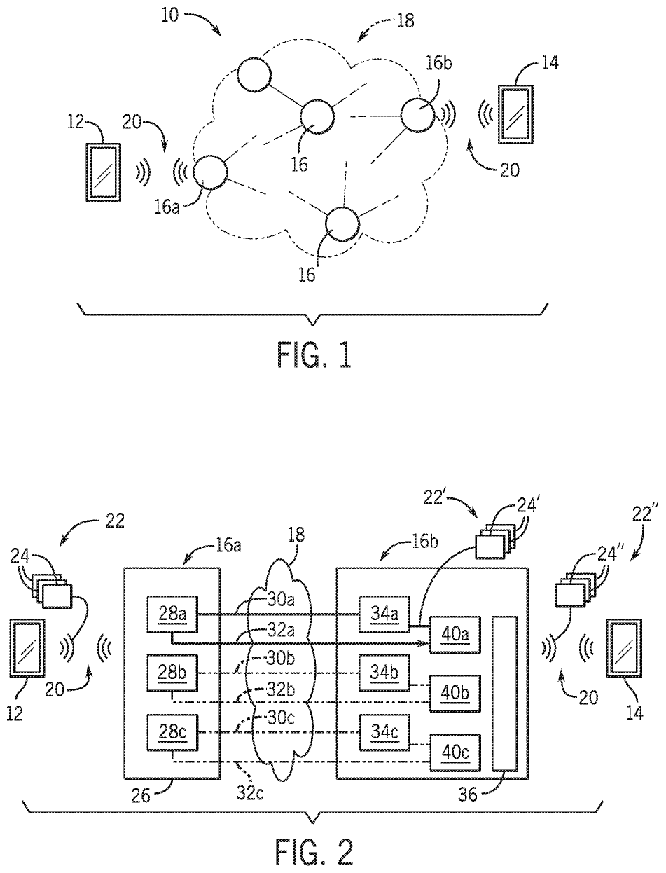

Referring now to FIG. 1, an example video communication system 10 may employ a video transmitting device 12, for example, a mobile phone, having video and audio capabilities communicating a video and audio stream to a video receiving device 14 such as another mobile phone. Generally, each of the video transmitting device 12 and the video receiving device 14 may include an internal computer executing a stored program and may provide a display screen, battery power, and cellular radio communication circuitry as is generally understood in the art.

The video transmitting device 12 will typically communicate video to the video receiving device 14 through a network 18, the video transmitting device 12 communicating first with an edge node 16a, for example, using a wireless link 20 such as a cellular radio system. The edge nodes 16a may then in turn communicate through the network 18 composed of various other nodes 16, as with the structure of the Internet, to a second edge node 16b. The second edge node 16b may then communicate wirelessly with the video receiving device or team.

The present invention is not limited to mobile devices used as the video transmitting device 12 and video receiving device 14 but can also include desktop computer systems and the like. Nevertheless, the example of mobile devices underscores a particular feature of the present invention in being able to operate with battery-powered devices having power storage limitations and limited computer processing power making it impractical to implement the invention directly. This limitation is overcome by provisioning edge nodes 16a associated with the video transmitting device 12 with specialized hardware for running machine learning algorithms such as graphic processing units (GPU) as well as the hardware required for standard network routing between multiple ports including network interface cards, high-speed memories, and the like to implement the present invention.

Thus, in at least one embodiment of the invention, machine learning features of the present invention as will be described may be implemented at the edge node 16a associated with the video transmitting device 12 making the present invention practical for current mobile devices.

Referring now also to FIG. 2, the edge node 16a, when receiving a video stream 22, may implement an adaptive bit rate compression system in which the video stream 22 (comprising successive video frames 24) is routed to a compressor block 26 with multiple video compressor systems 28a-28c each providing for a different amount of compression, that is, different reductions in the bit rate of the video stream 22. It will be understood that this representation of the compressor systems 28a-28c is a simplified functional representation and that there may be more or fewer compressor systems 28 and they in fact may be implemented by a single device sequentially or in interleaved fashion.

Each of these compressor systems 28a-28c produces a different compressed video data stream 30a-30c, respectively, that may be selectively transmitted (for example, using a multiplexer communicating with an individual network port, not shown). A determination of which compressor system 28a-28c to use can be determined by methods well known in the art of adaptive bit rate transmission and may change dynamically during the transmission, for example, with a transmission starting at a low bit rate or high compression and, depending on the channel path or the reception at the receiving device 14, moving to a higher bit rate and lower compression upon the receiving device requesting a higher bit rate. This change in bit rate compression can be made dependent on any of the bandwidth conditions of the wireless link 20 or network 18, and/or hardware limitations of the transmitting device 12 or receiving device 14 including processor power or display resolution.

Each of the compressor systems 28a-28c may also provide for a corresponding super resolution signal 32a-32c transmitted with the corresponding compressed video data stream 30a-30c. The super resolution signals 32a-32b are obtained from the machine learning super resolution model that is developed at the node 16a. These super resolution signals 32 provide the information (for example, model weights) necessary to allow that model to be used to boost the resolution at the node 16b as will be discussed in more detail below.

Referring still to FIG. 2, the edge node 16b receiving the compressed video data stream 30 may have decompressors 34a-34c matching compressor systems 28a-28c to receive the compressed video data stream 30 from the particular compressor system 28a-28c. These decompressors 34a-34c decompress that compressed video data stream 30 into the decompressed video frames 24′ of a decompressed video stream 22′.

These decompressed video frames 24′ of decompressed video stream 22′ may then be received by a corresponding super resolution model 40a-40c that operates to boost the apparent resolution of the received frames 24′ to produce super resolution frames 24″ of an ultimate video stream 22″.

The output of each decompressor 34, or when there is a super resolution post processor 40 as shown, is received by selector switch 36 to provide its output to the receiving device 14 from the particular decompressor 34 which is then active corresponding to the particular active compressor system 28. Alternatively, the output of each decompressor 34 may be received directly by the selector switch 36 to be viewed directly on the display of the receiving device 14 when super resolution is not desired or is optionally absent.

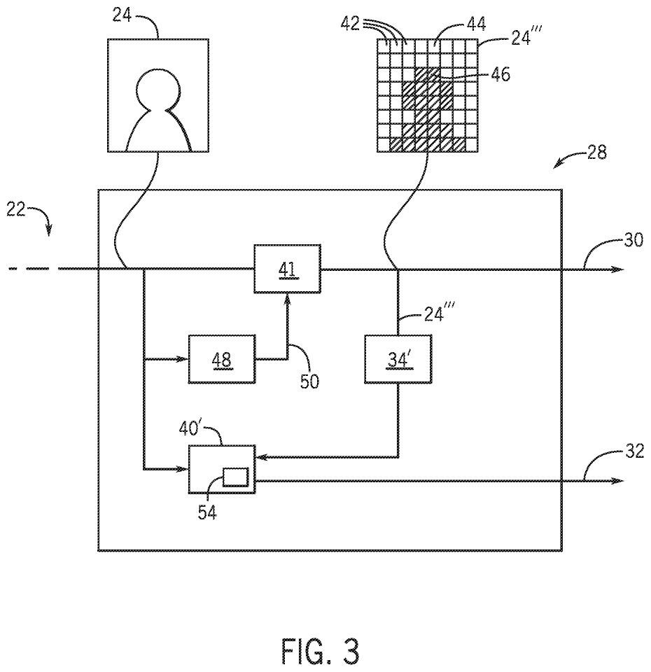

Referring now to FIG. 3, each of the compressor systems 28 may be of similar construction differing only according to the parameters of the encoding process and in particular to how much compression of the bit rate from the video stream 22 is performed. In one embodiment, successive frames 24 of the input video stream are received by a compressor 41, for example, implementing a region of interest (ROI) sensitive compression algorithm that divides the frame 24 into a set of macro-blocks 42 which may each affect a different degree of bit rate reduction by adjustment of quantization parameters generally known in the art. The resulting transmitted video data stream 30 will provide for multiple macro-blocks 42 having either a lower bit rate 44 which may vary according to other compression features such as the temporal or spatial compressions discussed above (indicated by no crosshatching in FIG. 3) and a higher bit rate 46 (indicated by crosshatching) generally higher than the lower bit rate 44 but also varying according to temporal and spatial compression.

Compression algorithms suitable for the compressor 41 (modified as necessary to receive ROI information for adjusting bit rates) may include, for example, MPEG2 described in Barry G Haskell, Atul Puri, and Arun N Netravali, “Digital video: an introduction to MPEG-2,” Springer Science & Business Media, 1996, or H.264 as described in Thomas Wiegand, Gary J Sullivan, Gisle Bjontegaard, and Ajay Luthra, “Overview of the H 264/AVC video coding standard,” IEEE Transactions on Circuits and Systems for Video Technology, 13(7):560-576, 2003, or HEVC described in Gary J Sullivan, Jens-Rainer Ohm, Woo-Jin Han, Thomas Wiegand, et al, “Overview of the High Efficiency Video Coding (HEVC) Standard,” IEEE Transactions on Circuits and Systems for Video Technology, 22(12):1649-1668, 2012, or VP8 as described in Jim Bankoski, Paul Wilkins, and Yaowu Xu, “Technical Overview of VP8, an Open Source Video Codec for The Web,” in 2011 IEEE International Conference on Multimedia and Expo, pages 1-6. IEEE, 2011, or VP9 described in Debargha Mukherjee, Jim Bankoski, Adrian Grange, Jingning Han, John Koleszar, Paul Wilkins, Yaowu Xu, and Ronald Bultje, “The Latest Open-Source Video Codec VP9-an Overview and Preliminary Results,” in Picture Coding Symposium (PCS), pages 390-393. IEEE, 2013, or AVP1 developed by the Alliance for Open Media of Wakefield, Mass. 01880 USA.

Importantly, compressor 41 takes the uncompressed video frames 24 from the input video stream 22 and produces a compressed video data stream 30 of compressed video frames 24′″ that can be decompressed by standard decompression algorithms implemented by the decompressors 34. In this way, the invention in a basic embodiment does not require extensive changes to the infrastructure of the network 18 and in particular to exit-edge nodes 16b.

Generally, the video data streams 30 may carry with it, per conventional compression protocols, an indication in metadata of how it is to be decoded essentially indicating the amount of compression use for each of the macro-blocks 42.

Referring still to FIG. 3, each frame 24 of the input video stream 22 may also be received by a machine learning model 48 that is trained to receive the frames 24 and to extract a region of interest 50 from the frame 24 defining a reduced portion of each frame 24 having greater interest to a typical viewer. This region of interest 50 will be provided to the compressor 41 to control the adjustments in bit rate described above.

The machine learning model 48 may have an architecture following machine learning models used for semantic segmentation networks, for example, being a many layered convolutional neural network. Similarly, the machine learning model 48 may be trained using techniques known for semantic segmentation networks, for example, to define a region of interest that extract a person's body from the frame 24 or a person's face, or that identifies a black/whiteboard or sheet of paper with diagrams on it. Training and architectures for the machine learning model 48 may follow the teachings of Jonathan Long, Evan Schelhamer, and Trevor Darrell, “Fully Convolutional Networks for Semantic Segmentation,” in Proceedings of the IEEE Conference on Computer Vision and Pattern Recognition, pages 3431-3440, 2015. Example architectures and training of machine learning model 48 include, for example, DeepLab described in Liang-Chieh Chen, George Papandreou, Iasonas Kokkinos, Kevin Murphy, and Alan L Yuille, “DeepLab: Semantic Image Segmentation with Deep Convolutional Nets, Atrous Convolution, and Fully Connected CRFS,” arXiv preprint arXiv:1606.00915, 2016 (for example, for face detection) and MobileNet SSD described in Wei Liu, Dragomir Anguelov, Dumitru Erhan, Christian Szegedy, Scott Reed, Cheng-Yang Fu, and Alexander C Berg, “SSD: Single Shot Multibox Detector,” in European Conference on Computer Vision, pages 21-37. Springer, 2016.

Such a machine learning model 48 may operate at a pixel level to extract the region of interest 50 for the compressor 41 and thus may accommodate a macro-blocks 42 of different sizes and shapes to readily be adapted to a variety of compression techniques.

Referring now momentarily to FIG. 5, generally, the machine learning model 48 may be pre-trained using a training set 43 of example videoconference frames 24, for example, including corresponding pairs of images of a person 25 and mask frame 51, for example, having binary pixel values defining either a mask 53 outlining a region of interest 50 such as the person in the video frames 24 or an extra-mask region 55 outside of this region of interest 50. This training set may be prepared “offline” and may make use of the ability of machine learning models to generalize concepts such as faces, people, and whiteboards usable with arbitrary later video streams. Generally, the training set will provide representative videos of many different individuals in many different environments.

Referring again to FIG. 3, each frame 24 of the input video stream 22 is also provided to a super resolution preprocessor 40 which receives both each uncompressed frame 24 and its corresponding compressed frame 24′″ after decompression by a decompressor 34′. The decompressor 34′ matches in operation a corresponding one of the decompressors 34a-34c found at the edge node 16b discussed above with respect to FIG. 2. This decompressor 34′ produces decoded frames 24′ closely representing the data that will be ultimately reconstructed at the edge node 16b by the decompressors 34a-34c which may include some artifacts from region of interest compression, noise, and compression loss.

Each frame 24 and the decoded frame 24′ together form multiple frames to provide a teaching set that evolves during transmission of the video and which is used by the super resolution preprocessor 40 to develop a set of model weights 54 (or neuron weights) that can be used by the super resolution preprocessor 40 to generate approximations of frames 24 from corresponding compressed frame 24′ of the video data stream 30. These model weights 54 are then transmitted as the model data 32 to the edge node 16b for use by the super resolution models 40a-40c and will be updated periodically with additional video transmission.

In one embodiment, super resolution preprocessor 40 may be pre-trained offline with general image data and then may be boosted in its training using actual video frames. Ideally the model is small so that the weights of the model can be readily transmitted.

In one example the super resolution models 40′ and 40a-40c may following the teachings of the CARN model described in Namhyuk Ahn, Byungkon Kang, and Kyung-Ah Sohn, “Fast, Accurate, And Lightweight Super-Resolution With Cascading Residual Network,” in Proceedings of the European Conference on Computer Vision (ECCV), pages 252-268, 2018.

As noted above, at the edge node 16b, decompressed frames 24″ from the decompressors 34 may be received by one of super resolution model 40a-40c associated with the particular adaptive bit rate stream of video data stream 30 and model data 32. The corresponding one of super resolution models 40a-40c receive the training weights 54 which allow it to take the lower resolution decompressed frames 24″ produced by the decoders 34a-34c of the edge node 16b and improve the resulting image through the benefits of machine learning to produce the frames 24′″. For this purpose, as noted, each of the super resolution post processors 40 will have an architecture similar to super resolution preprocessor 40 so that the model weight 54 may successfully be translated from the transmitter side to the receiver side.

It will be appreciated that the operation of the machine learning model 48 determining the ROI 50 is thus tightly linked to the operation of the super resolution post processor 40 providing super resolution post processor 40 through the training set which includes enhanced bit rates for the region of interest. For this reason, the super resolution models 40a-40c will also tend to preferentially improve the region of interest 50.

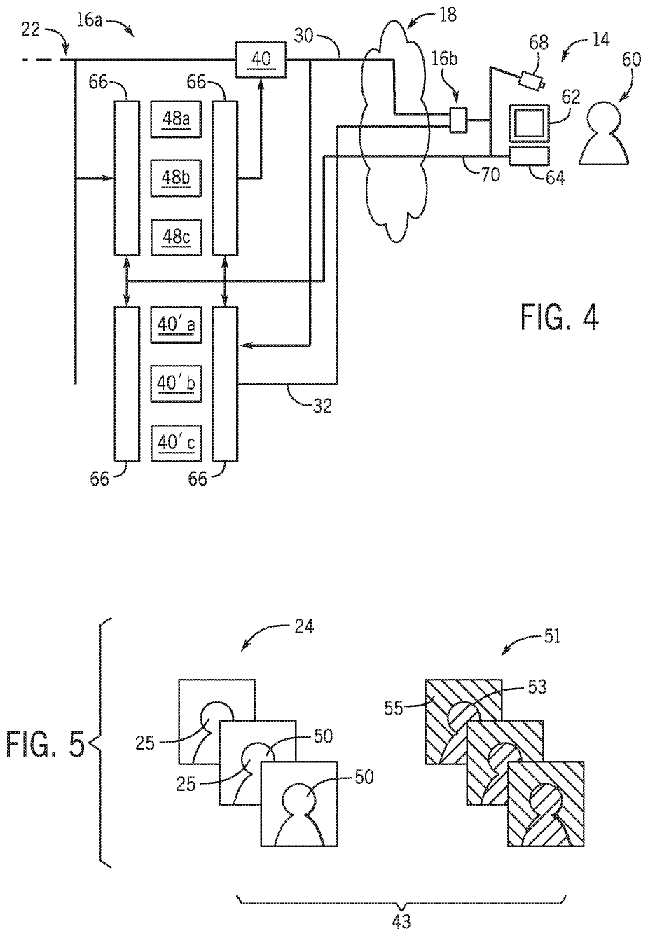

Referring now to FIG. 4, in one embodiment, a user 60 at the receiving device 14 may view the fully decoded frames 24′″, for example, on a display 62 and may select a desired region of interest category 70, for example, through a user input device 64 such as a keyboard or the like or automatically, for example, by means of eye tracking camera 68 observing those areas of the image that are of interest to the user 60. In the former case, the user 60 may select among specific categories or regions of interest (e.g., faces, whiteboards) or types of programming, for example, a videoconference, a sporting event, or the like to enable content identification of particular regions of interest, for example, players or a ball or puck.

The resulting region of interest categories 70 may be transmitted to the edge node 16a and used to select among a variety of different machine learning models 48 tuned for particular regions of interest associated with those categories, for example, using selector switches 66 to invoke different machine learning engines 38 and likewise to select one or more of the super resolution models 40′a-40′c which may be trained in parallel, for example, depending on the particular machine learning model 48 selected so as to be tuned to the type of compression being performed.

It will be appreciated that the region of interest category 70 may also be selected by the transmitter, for example, choosing a particular category of content of the video stream (e.g., sporting event, drama, new show, or the like) to select custom region of interest selections or combinations of selections.

It will be appreciated that the super resolution post processors 40 may also be used independently with the described region of interest-based compression using machine learning and may be used with an arbitrary region of interest identification system or compression system that does not use a region of interest identification. Such a system would modify that described with respect to FIG. 3 by eliminating the machine learning model 48.

It will be recognized that during application such as videoconferencing, the exchange of video information between the video transmitting device 12 and the video receiving device 14 will be bidirectional. Accordingly, the transmitting and receiving functions described above may be reversed as well as the direction of transmission through the network 18. For this reason, generally each of edge node 16a and 16b will be provisioned with machine learning capable hardware and software.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

1. A video compression system comprising:
a region of interest extractor receiving an input stream of a first set of video frames and identifying a region of interest by applying the input stream of the first set of video frames to a machine learning model trained to identify a predetermined physical object in the input stream of the first set of video frames by defining a region of interest extracting the predetermined physical object, the training of the machine learning model employing a training set linking a second set of video frames depicting the predetermined physical object to the predetermined physical object;
a bit rate compressor receiving an input stream of the first set of video frames and the region of interest from the region of interest extractor and outputting an output stream of video frames based on both the input stream of the first set of video frames and a region of interest defining a first portion of the first set of video frames of the input stream;
wherein the bit rate compressor encodes the first portion of the first set of video frames at a relatively higher bit rate than a second portion of the first set of video frames outside of the first portion.

2. The video compression system of claim 1, wherein the training set links the second set of video frames and corresponding mask frames outlining the predetermined physical object in a portion of the second set of video frames related to the predetermined physical object.

3. The video compression system of claim 2, wherein the mask frames identify in the second set of video frames of the training set a region of interest using a predetermined physical object selected from the group consisting of at least one of a person, a person's face, or a black/whiteboard in the video frames of the training set.

4. The video compression system of claim 1, wherein the higher bit rate is realized by at least one of a greater bit depth in pixels of the output stream of video frames and a greater bit transmission rate of pixels in the output stream of the video frame.

5. The video compression system of claim 1, wherein the region of interest extractor includes multiple machine learning models each trained to identify a different predetermined physical object in the stream of the first set of video frames defining a region of interest in the input stream of the first set of video frames and wherein the video compression system includes an input for receiving a region of interest selector signal to select among the different multiple machine learning models.

6. The video compression system of claim 1, wherein the bit rate compressor divides each video frame of the input stream into macro-blocks and provides a different amount of compression to corresponding macro-blocks of each video frame of the output stream according to whether the region of interest overlaps the macro-block.

7. The video compression system of claim 6, further including a bit rate decompressor communicating with the bit rate compressor to receive the output stream to provide different amount of decompression to each macro-block of the output stream according to information transmitted with the macro-blocks of the output stream.

8. The video compression system of claim 7, further including a bit rate decompressor communicating with the bit rate compressor to receive the output stream and to decompress the output stream according to one of: MPEG2, H.264, HEVC, VPN8, VP9, and AVP1.

9. The video compression system of claim 1, wherein the machine learning model of the region of interest extractor is a deep neural network being a convolution on a neural network having more than three layers.

10. The video compression system of claim 1, further including a super resolution preprocessor receiving the input stream of the first set of video frames and the output stream of video frames as a training set to develop a machine learning super resolution model relating the input video stream to the output video stream and, wherein the video compression system transmits weights associated with the machine learning super resolution model with the output stream of video frames for use in reconstructing a viewable video stream.

11. The video compression system of claim 10, further including a super resolution post processor receiving the transmitted weights from the super resolution preprocessor and communicating with a bit rate decompressor receiving the output stream of video frames from the bit rate compressor to decompress the output stream into a decompressed video stream;
wherein the super resolution post processor applies the decompressed video stream to the machine learning super resolution model using the transmitted weights to reconstruct the viewable video stream.

12. The video compression system of claim 10, wherein the machine learning model of the first and super resolution post processors are a deep neural network being a convolutional neural network having more than three layers.

13. The video compression system of claim 10, wherein the weights associated with the machine learning super resolution model are updated on a periodic basis during the video transmission.

14. The video compression system of claim 1, wherein the video compression system further provides for multiple network connections and routing data among those connections.

15. The video compression system of claim 1, further including a portable wireless device providing a video camera producing the input stream of video frames.

16. The video compression system of claim 1, wherein the training set links pairs of an images comprised of an image of the predetermined physical object, and a mask providing an outline of the predetermined physical object.
